(19) United States
(12) Patent Application Publication
(10) Pub. No.: US 2013/0094244 A1
(43) Pub. Date: Apr. 18, 2013

(54) LIGHT GUIDE PLATE AND METHOD FOR MANUFACTURING THE SAME

(71) Applicant: YI-CHIEH MIAO, Shindian (TW)

(72) Inventor: YI-CHIEH MIAO, Shindian (TW)

(73) Assignee: FIH (HONG KONG) LIMITED, Kowloon (HK)

(21) Appl. No.: 13/314,554

(22) Filed: Dec. 8, 2011

(30) Foreign Application Priority Data
Oct. 12, 2011 (TW) 100137064

(51) Int. Cl. F21V 7/04; G02B 6/10; G02B 6/26

(52) U.S. Cl. 362/609; 385/39; 264/1.24

(57) ABSTRACT

A light guide plate includes a light guide portion, and a number of light gathering portions. The light guide portion defines a plurality of openings. The light gathering portions are formed on the light guide portion. Each light gathering portion includes a light receiving part and a light reflecting part. The light receiving part partially surrounds one of the openings. The light reflecting part includes a sloping reflecting surface formed between the light receiving part and the light guide portion.

### BACKGROUND

1. Technical Field

The disclosure generally relates to light guide plates and methods for manufacturing the same, and particularly to a light guide plate for a portable electronic device such as mobile phone and a method for manufacturing the light guide plate.

2. Description of Related Art

Light emitting diodes (LEDs) are usually positioned on just one side of a light guide plate and serve as the source for a back lighting module of a mobile phone. The light guide plate may be designed to have a standard rectangular shape, accordingly, illumination by the LED is very limited. The small amount of received light decreases the uniform brightness of the light guide plate.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the disclosure.

FIG. 1 is a schematic view of a light guide plate, according to an exemplary embodiment of the disclosure.

FIG. 2 is an enlarged view of the circled portion II of the light guide plate in FIG. 1, according to an exemplary embodiment of the disclosure.

FIG. 3 is a cross-sectional view taken along line III of FIG. 1, according to an exemplary embodiment of the disclosure.

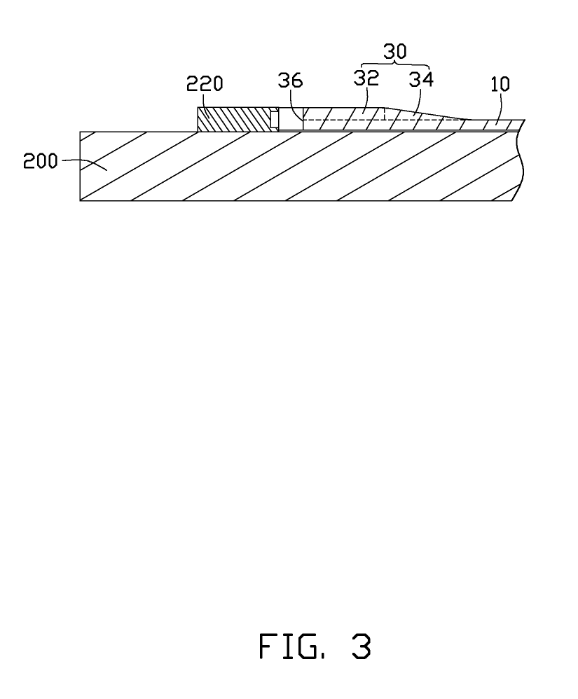

FIG. 4 is an exploded cross-sectional view of a lower mold apparatus, according to an exemplary embodiment of the disclosure.

FIG. 5 is a cross-sectional view of a mold apparatus, according to an exemplary embodiment of the disclosure.

### DETAILED DESCRIPTION

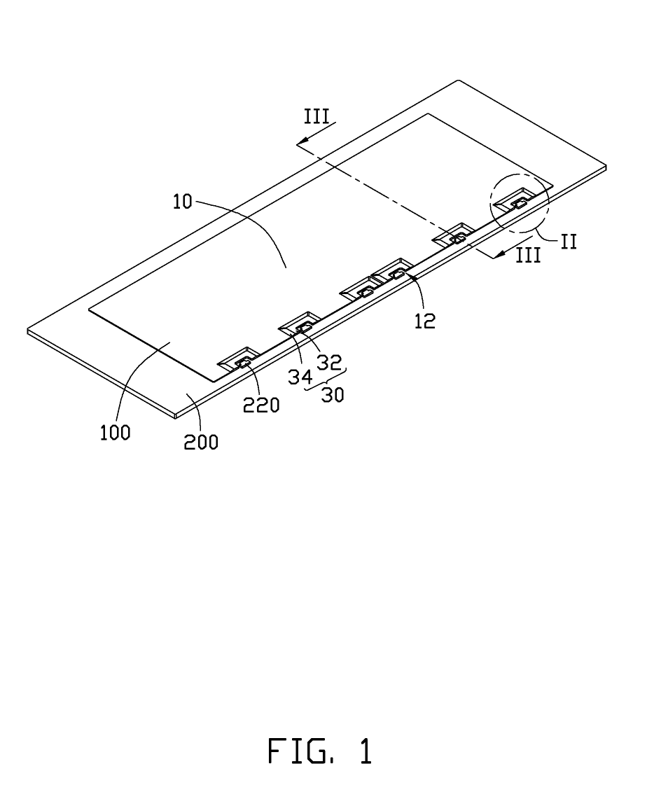

FIG. 1 is a schematic view of a light guide plate 100 used in a portable electronic device, according to an exemplary embodiment. The portable electronic device includes a circuit board 200, and a plurality of light sources 220 positioned on the circuit board 200. In this embodiment, each light source 220 is a light emitting diode (LED).

The light guide plate 100 is positioned on the circuit board 200, and is for diffusing light emitted from the light sources 220 and providing an even back light for a keypad of the portable electronic device. The light guide plate 100 includes a light guide portion 10 and a plurality of light gathering portions 30. The light guide portion 10 and the light gathering portions 30 are integrally molded.

The light guide portion 10 is substantially a rectangular plate having a high light guiding character and may be made of one or more materials selected from a group consisting of polycarbonates, thermoplastic polyurethanes, and silicones. A plurality of light emitting points (not shown) is formed on the light guide portion 10 for example by printing, laser or rolls forming. Light emitted from the light source 220 can be refracted at the light emitting points and transmitted to all portions of the light guide plate 100 to enhance the brightness of the light guide plate 100.

A plurality of rectangular openings 12 are defined in one side of the light guide portion 10. The openings 12 are equal in number to the number of light sources 220. Each light source 220 corresponds to one of the openings 12, and is positioned in one opening 12.

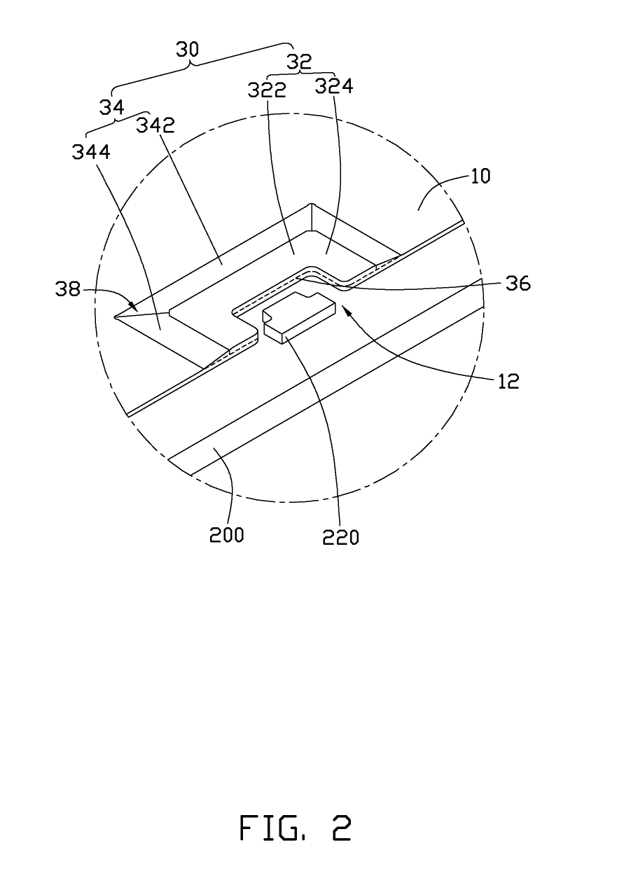

Also referring to FIG. 2, the light gathering portions 30 are made of silicone. Each light gathering portion 30 is formed on the light guide portion 10 as a liner of each of the openings 12. Each light gathering portion 30 includes a light receiving part 32 and a light reflecting part 34.

The light receiving part 32 is substantially U-shaped. Each light receiving part 32 partially surrounds a light source 220 and includes a first light receiving section 322 and two opposing second light receiving sections 324 at each end of the first light receiving section 322. The first light receiving section 322 and the two second light receiving sections 324 are positioned on the light guide portion 10 surrounding the corresponding opening 12. One side of the first light receiving section 322 is coplanar with the edge of the light guide portion 10 facing the light source 220 and forms a light receiving surface 36 to receive the greatest amount of light.

The light reflecting part 34 is positioned furthest from the light sources 220. The light reflecting part 34 is also substantially U-shaped and includes a first light reflecting section 342 and two opposing second light reflecting sections 344 at each end of the first reflecting section 342. The first light reflecting section 342 and both of the second light reflecting sections 344 are in the shape of a ramp. Each of the first light reflecting section 342 and the second light reflecting sections 344 has a triangular cross-section. A U-shaped sloping light reflecting surface 36 is formed between the light receiving part 32 and the light guide portion 10. Thus, the light received by the light receiving part 32 is reflected by the sloping light reflecting surface 36 and enters into the light guide portion 10 to enhance the brightness of the light guide plate 100.

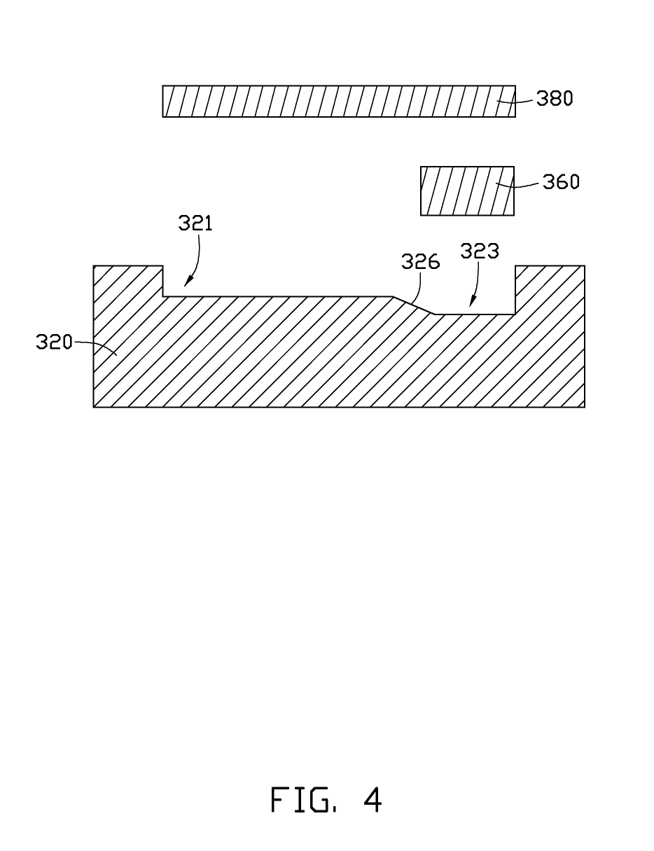

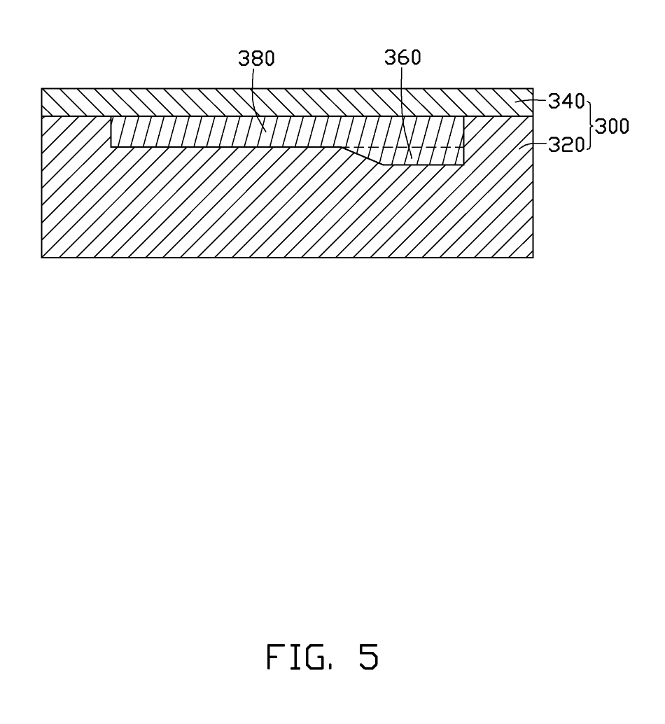

Referring to FIGS. 4-5, a mold apparatus 300 for manufacturing the light guide plate 100 includes a lower mold 320 and an upper mold 340. The lower mold 320 defines a first cavity 321 and a second cavity 323 deeper than the first cavity 321. The second cavity 323 communicates with the first cavity 321. An inclined surface 326 is formed between the first cavity 321 and the second cavity 323 and interconnects the first cavity 321 and the second cavity 323. A method of manufacturing the light guide plate 100 by the mold apparatus 300 may include following steps:

In step S1, an amount of silicone 360 is placed in the second cavity 323.

In step S2, a plate 380 is placed in the first cavity 321 and the second cavity 323 and covers the silicon 360 received in the second cavity 323.

In step S3, the upper mold 321 and the lower mold 321 are closed so as to integrally mold the plate 380 and the silicone 360 under the conditions of high pressure and low temperature.

In step S4, the upper mold 321 is opened/detached from the lower mold 321. A plurality of openings 12 are defined by a punching process and thus the forming of the light guide plate 100 is finished.

In other embodiments, the light gathering portions 30 may be positioned on both sides of the light guide plate 100 to increase the lighting effectiveness of the light guide plate 100. In addition, when the light guide plate 100 is installed on the circuit board 200, the light gathering portions 30 facing the circuit board 200 can be used as supports for the light guide portion 10 to prevent the light guide portion 10 from being suspended and deformed.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A light guide plate comprising:
a light guide portion defining a plurality of openings; and
a plurality of light gathering portion formed on the light guide portion, each light gathering portion comprising a light receiving part and a light reflecting part formed at an out side of light receiving part, the light receiving part partially surrounding one of the openings, the light reflecting part comprising a sloping reflecting surface formed between the light receiving part and the light guide portion.

2. The light guide plate of claim 1, wherein the light receiving part is substantially U-shaped and comprises a first light receiving section and two opposite second light receiving sections respectively connected to two ends of the first light receiving section.

3. The light guide plate of claim 1, wherein the light reflecting part is substantially U-shaped and comprises a first light reflecting section and two opposite second light reflecting sections respectively connected to two ends of the first light reflecting section, each of the first light reflecting section and the light reflecting sections are in the shape of a ramp.

4. The light guide plate of claim 1, wherein the light receiving part is made of one of the group consisting of polycarbonate, thermoplastic polyurethanes, or silicone resin.

5. The light guide plate of claim 1, wherein the light gathering portion is made of silicone.

6. A portable electronic device comprising:
a circuit board;
a plurality of light sources; and
a light guide plate positioned on the circuit board, the light guide plate comprising:
a light guide portion defining a plurality of openings, the light sources respectively received one of the openings; and
a plurality of light gathering portion formed on the light guide portion, each light gathering portion comprising a light receiving part and a light reflecting part formed at an out side of light receiving part, the light receiving part partially surrounding one of the openings, the light reflecting part comprising a sloping reflecting surface formed between the light receiving part and the light guide portion.

7. The portable electronic device of claim 6, wherein the light receiving part is substantially U-shaped and comprises a first light receiving section and two opposite second light receiving sections respectively connected to two ends of the first light receiving section.

8. The portable electronic device of claim 6, wherein the light reflecting part is substantially U-shaped and comprises a first light reflecting section and two opposite second light reflecting sections respectively connected to two ends of the first light reflecting section, each of the first light reflecting section and the light reflecting sections are in the shape of a ramp.

9. The portable electronic device of claim 6, wherein the light gathering portion are formed on the light guide portion facing the circuit board and supporting the light guide portion.

10. The portable electronic device of claim 6, wherein the light receiving part is made of one of the group consisting of polycarbonate, thermoplastic polyurethanes, or silicone resin.

11. The portable electronic device of claim 6, wherein the light gathering portion is made of silicone resin.

12. A method for manufacturing a light guide plate, the method comprising:
providing a mold apparatus, the mold apparatus comprising a upper mold, and a lower mold, the lower mode defining a first cavity and a second cavity deeper than the first cavity, the second cavity communicating with the first cavity, a inclined surface formed between the first cavity and the second cavity;
putting an amount of silicone in the second cavity;
putting a plate made of one of the group consisting of polycarbonate, thermoplastic polyurethanes, or silicone in the first cavity and covering the silicon;
closing the upper mold and the lower mold for integrally molding the plate and the silicone under the conditions of a high pressure and a low temperature.

13. The method for manufacturing a light guide plate of claim 12, further comprising forming plurality of openings in the plate.
